(19) United States
(12) Patent Application Publication
(10) Pub. No.: US 2003/0229854 A1
(43) Pub. Date: Dec. 11, 2003

(54) Text extraction method for HTML pages

(76) Inventor: Mlchel Lemay, Quebec (CA)

Correspondence Address: OGILVY RENAULT, 1981 MCGILL COLLEGE AVENUE, SUITE 1600, MONTREAL, QC, H3A2Y3, CA

(21) Appl. No.: 10/407,203

(22) Filed: Apr. 7, 2003

Related U.S. Application Data
(63) Continuation of application No. PCT/CA00/01225, filed on Oct. 19, 2000.

(51) Int. Cl. G06F 15/00

(52) U.S. Cl. 715/513

(57) ABSTRACT

An object of the present invention is to extract only the relevant information from a document (such as an HTML web page) to facilitate the summarizing of the document. There is provided a method of extracting a portion of text from a document including at least one table and cells within the at least one table, for the purposes of generating a summary of contents of the document. The method comprises: identifying cells within the document; determining a text size of the cells; selecting some of the cells using the text size of the cells; extracting in a text only output a text content of the selected cells; whereby the text only output extracted can be used to produce a summary of a portion of text of the document excluding text from non-selected cells.

### CROSS-REFERENCE TO RELATED APPLICATIONS

This application is a continuation-in-part of PCT application no. PCT/CA00/01225 filed Oct. 19, 2000 by Applicant.

### FIELD OF THE INVENTION

The invention relates to the field of extracting the contents of documents, especially the contents of web pages.

### BACKGROUND OF THE INVENTION

Because of the incredible quantity of documents available on the Internet, people surfing on the Internet often have the impression that they will not be able to find what they are looking for in a timely fashion. When search tools return a list of hits for particular keywords which comprises more than 15 hits, it is inefficient for a user to follow each link and read through the material available on the web site before deciding if the hit is relevant.

Summarizing tools have been created which try to extract the particular meaning of the contents of documents using statistical analysis of the words to better direct the users through the documents available. These summarizing tools are very efficient with conventional documents such as papers, essays, books, etc., but yield very limited results when used with web pages because of the presence of banners, links, tables, frames and other presentation and display tools which separate and organize portions of text.

Many text summarizing tools are available on the market. A few such tools are the ConText tool by Oracle, the Text Extractor by National Research Council of Canada (NRC), the Summarizer SDK by inxight and the Word AutoSummarize feature by Microsoft. Also available is the text-only save option in Internet Explorer 5.0 by Microsoft. It allows to save a document without the HTML formatting.

NRC Extractor takes a text file as input and generates a list of keywords and keyphrases as output. The output keyphrases are intended to serve as a short summary of the input text file. Extractor uses a statistical approach to summarizing. Using this approach, the frequency of appearance of words and their derivatives (stems) together with their relative position with respect to the top of the page, among others, are important factors. Extractor uses 12 statistical parameters. As can be understood from this description of Extractor, when such an algorithm is faced with a web page to be summarized, the summary is polluted with many words and phrases irrelevant to the contents of the page but highly relevant to the navigation on the site.

Referring to FIG. 1, a web page including a news article is shown. This web page was available on Oct. 17, 2000 at www.zdnet.com/zdnn/stories/news/0,4586,2619342,00.html. The contents of the web page are diluted by words such as Zdnet, Page one, Business, Internet, Contact Us, Breaking news, etc. These words, which are irrelevant to the contents of the news item but highly relevant to the web site, are frequent and often appear above the text of the article.

FIG. 1 is a schematic representation of the web page mentioned above. The contents of the web page has been divided into tables to highlight the structure of the document. The browser 19 displays the web page. The following is a description of the contents of each table identified in the web page:

20. ZDNet navigation hyperlinks: Cameras, Reviews, Shop, Business, Help, News, Electronics, GameSpot, Tech Life, Downloads, Developer.

21. The ZDNet banner with their logo.

22. ZDNet's highlighted hyperlinks: Tech Business insider, Outlet Store Savings, Free Downloads.

23. The hierarchical position of the article: ZDNet>ZDNet News Page One>Business>Lane gets new job, blasts Ellison.

24. An ad banner, in this case, MasterCard™.

25. A Search For tool.

26. The ZDNet Business section logo together with the Wall Street Journal logo.

27. The Sections frame.

28. The Breaking news frame with a sample of 5 news items.

29. The hyperlinks for the following news sections: Page One, Business, Commentary, Computing, eCrime, Law and You, International, Internet, Investor, Mac/Apple, TalkBack Central.

30. The top stories hyperlinks with a sample of 6 news items.

31. The hyperlinks to communicate with ZDNet: Contact Us, Corrections, Custom News.

32. The operations section: E-mail this, Print this, Save this.

33. A hyperlink to the Air Tech news radio.

34. An ad frame.

35. Related Sites hyperlinks such as AnchorDesk, Inter@ctive Week, MSNBC News, eWEEK, Sm@rt Partner, ZDNet Asia, etc.

36. The main body and contents of the news item, a news article.

37. The second portion of the main body and contents of the news item.

38. A table of hyperlinks to other related sites.

39. An hyperlink to the tool to submit comments on the news item.

40. Hyperlinks to more articles on the same story.

41. ORCL links: News, Profile, Chart, Estimates.

42. Short summary of the news article.

Not shown are other hyperlinks to ads, related articles and related web sites located at the bottom of the web page and accessible by scrolling the page using the browser's tools.

Microsoft Internet Explorer 5.0 allows a user to save a web page as text only. This text-only save option extracts all text from the page, even text in hyperlinks.

Table 1 shows a text-only version of the web page of FIG. 1 obtained using the text-only save of Microsoft Internet Explorer 5.0.

TABLE 1
Text-only version of the web page of FIG. 1.

ZDNet: News: Lane gets new job, blasts Ellison | Cameras | Reviews | Shop|
Business | Help | News | Electronics | GameSpot | Tech Life |Downloads|
Developer
IPO News And Analysis
Outlet Store Savings
Free Downloads
ZDNet > ZDNet News Page One > Business > Lane gets new job, blasts Ellison
Search For:NewsAll ZDNetThe Web Search, Tips, Power Search
Page One, Business, Commentary
Computing, eCrime, Law & You, International, Internet, Investor, Mac/Apple,
TalkBack Central
Headline Scan, News Briefs, News Archive, News Specials
Contact us, Corrections, Custom News
On the Air, Tech news, 24 hours a day, Play Radio
Related Sites , AnchorDesk, Inter@ctive
Week, MSNBC News, eWEEK, Sm@rt Partner
ZDNet Asia, ZDNet UK, ZDNet Australia, ZDNet France, ZDNet Germany, ZDNet
Japan, ZDNet China
Lane gets new job, blasts Ellison
Former top lieutenant Ray Lane and Oracle CEO Larry Ellison continue
to battle, even as Lane takes a job with Kleiner Perkins.
By Lee Gomes, WSJ Interactive Edition
August 24, 2000 7:51 AM PT
Ray Lane, former No. 2 executive at Oracle Corp., hardly has a bad thing to
say about his former employer -- except that it is a company full of yes men
who tend to be less than candid about their products.
Lane abruptly left the business-software giant in June after an eight-year
stint. One reason was that his responsibilities as president and chief
operating officer had been reduced by Lawrence Ellison, Oracle's (Nasdaq:
ORCL) chief executive. Lane, 53 years old, said following his departure that
he wanted to devote more time to his two young children by his second
marriage.
Sound off here!!, Post your comment
Ellison vs. Lane
ZDNet Smart Business Magazine
Coop's Corner: Larry Ellison and Basura-gate
Ellison changes his account of Lane departure
Behind Lane's resignation at Oracle
Oracle's Ray Lane steps down
ORCL:News, Profile, Chart, Estimates
Wednesday, Lane announced that he will become a general partner at Kleiner
Perkins Caufield & Byers, the prominent Silicon Valley venture-capital firm.
And in an interview scheduled with that announcement, Lane harshly criticized
Ellison, making clear that his departure from Oracle wasn't amicable. In
response to Lane's comments, Ellison strongly defended himself and the
company.
A great admirer yet
Lane said he remains a great admirer of Oracle and Ellison. He said, for
example, that Ellison's oversight of the main Oracle database product in the
early 1990s “saved” the company, and that lately, Ellison has “reinvigorated”
Oracle to take advantage of the opportunities presented by the Internet. That
work made Lane's net worth, based largely in Oracle stock, soar to nearly a
billion dollars.
But Lane also said that Ellison is utterly dominating the company right
now, something that might prove to be harmful in the long run, since Oracle
won't be able to develop the strong management team it needs.
‘[The Oracle executives] aren't leaders. They just do what Larry says. They
wouldn't know how to make a decision without Larry making it for them.’ --
Ray Lane, former No. 2 executive at Oracle
“It's just like with kids,” Lane said. “If you make all their decisions
for them, they will go out as adults not knowing how to make decisions
themselves.” The executives now reporting to Ellison, said Lane, “are not
decision makers. They aren't leaders. They just do what Larry says. They
wouldn't know how to make a decision without Larry making it for them.”
Lane came to Oracle, of Redwood Shores, Calif., in 1992 at a time when the
company's credibility in the market was low. He said Wednesday that
studies he commissioned at that time found that many customers “would never
do business again with a Larry Ellison company.”
The reason, Lane said, is that Oracle would sell products it didn't have.
“Larry is a visionary, and expresses the vision so well that people believe
it's a product.” When he first got to Oracle, Lane said, “managers would be
willing to take the order and make a lot of money,” even though the products
often didn't exist. “That's the discipline I put into the company,” he said.
“I told the sales force, ‘After what Larry says is the vision, tell the
customer the truth about what we can actually deliver.’ ”
‘Needs more balance’
Lane indicated that he is worried that with him gone, Oracle might lapse back
to its old ways. “The company needs more balance,” he said.
Ellison rejected his former deputy's criticisms.
Oracle's managers, Ellison said, were in many cases chosen by Lane himself.
“He is criticizing his own team for being weak. When did they become yes men?
I am thrilled they are all here. They are delivering exceptional results.”
Ellison also said the company doesn't sell products it doesn't have.
“He is the soul, the conscience of Oracle, and the other 45,000 of us are
criminals?” Ellison asked. “It's astounding. We don't sell products that
don't exist because it's against the law.”
Even while he was at Oracle, Lane was sometimes outspoken on the subject of
Ellison. Once, for example, he described how top executives of Boeing Corp.
were no longer dealing with Oracle about an important “business-to-business”
contract because they were angry that Ellison had publicly stated,
incorrectly, that Oracle had won the deal.
Front Page, Tech Center, Money and Investing, Subscribe to wsj.com
And his latest comments about Oracle should be viewed in the context of
his new job. At Kleiner Perkins, he will be helping start-up companies in
business-to-business software and services, some of which may potentially
compete with Oracle.
Lane said he was attracted to the venture-capital job in large part because
it will mean less travel. “When you are spending 70 percent of your time on
airplanes, you have to step back and say, ‘Why am I doing this?’ ” He also
predicted a looming shakeout at many Internet companies, which will make his
sort of operational experience even more valuable, since he will be able to
provide guidance to the surviving companies.
Lane was originally slated to stay on Oracle's board following his departure.
He said Wednesday, though, that he might leave it in the fall, when his term
expires.
More stories on: Ellison vs. Lane
See also: Business section
Talkback:
Ellison claims “We don't sell p . . . - Daniel Welch
Sounds like Gates, Jobs and any . . . - de
The answer to Ellison's rhetori . . . - john major
Let me be the first to say that . . . - Les Claypool
I find that throughout life tha . . . - John Bannon
Les −> Nah . . . It's all Sun's f . . . - Dave Rothgery
Les: I really didn't start . . . - Phluux
Les Claypool, you forgot about . . . - mars boni
Did you ever notice its the com . . . - Mark Haliday
Anyone who believes Larry Ellis . . . - John Simpson
Mr. Ellison is the bad guy . . . . . . - Chris Papoudaris
Always research the company beh . . . - Dollie
Mark, actually I noticed compan . . . - Zheam
Did you ever notice how similar . . . - MC
05:46a NEC sets sail with Transmeta's Crusoe
05:46a Excite@Home offers do-it-yourself cable
05:39a Madonna gives cybersquatter the boot
04:44a Investor AM: Catalyst wanted to spur tech stocks
04:28a AMD ships 1.2GHz Athlons
More . . .
AOL wireless: No training wheels?
EFF defends nameless Netizens
Open-source angst: Fear of forking
NEC sets sail with Transmeta's Crusoe
Investor AM: Desperate for a catalyst
SDMI denies broken technologies
Business
Microsoft defectors gain momentum
Stock? Net execs want the cash
Commentary
Slater: Napster rocks the music world
Coursey: Is StarOffice Sun's ‘survivor’?
Computing
Sony launches Crusoe-based laptop
Handspring adds color PDA, GameFace
Internet
Outsider vows to clean up ICANN
Pop the cork on broadband bottlenecks
eCrime and Law
Cybersecurity: Don't trust the Feds!
Mitnick hacks federal DNA database
Mac
Apple: Two routes to Mac OS X
Apple cheers on MS at Office party
Oracle Corp.
Enter a company
Sponsored Links
Looksmart: Drive users to your site with Express Submit!
Rackspace: Managed Hosting in 24 hours or less.
No Credit? Get a MasterCard with NO Credit Checks!
ORACLE Zero to Portal @ Web Speed-Click here for a free Kit
PlanBee Free download - new personal productivity Internet tool
GREAT PC ClientPro Cn - 600MHz w/ 7.5 GB hard drive, from $1425!
Intel Manufacturer ShowcaseNeed More Help?
Shop Now!Shop at Dell's Home Solution Center - Dell Small Business
Center
Shop Now!Gateway Home Computing Center
Featured Links
Best Buys Shop Smart for scanners, digital cameras, monitors & more!
Get Help! Ask an expert a technical question -- LIVE!
Red Herring RISK-FREE! For insight into the business of technology.
Magazine Offers
LastChance Get Your Free Premiere Trial Copy of Expedia Travels!
Tech Jobs |ZDNet e-centives |Free E-mail |Newsletters |
Updates |MyZDNet |Alerts |Rewards |Join ZDNet |Members |
SiteBuilder
Feedback |Your Privacy |Service Terms |Advertise |About Us
Copyright © 2000 ZD Inc. All rights reserved. ZDNet and the ZDNet
logo are registered trademarks of ZD Inc.

When a text summarizer such as the NRC Extractor is used on a text-only version of a web page, the results are less than satisfying, as can be seen from the following keywords and keyphrases extracted by the NRC Extractor from the text-only version of Table 1.

Keyphrases: Lane, Ellison, Oracle, ZDNet, business, news, Larry

Highlights: 1. ZDNet>ZDNet News Page One>Business>Lane gets new job, blasts Ellison. 2. Ray Lane, former No. 2 executive at Oracle Corp., hardly has a bad thing to say about his former employer—except that it is a company full of yes men who tend to be less than candid about their products. 3. Coop's Corner: Larry Ellison and Basura-gate

From the web page of FIG. 1, it can be calculated that the useful portion of the document represents 57% of the contents of the web page (about 850 relevant words on a total of 1500). Therefore, 43% of the words of the document include links, comments, headers, footers, etc. Knowing that the success rate of Extractor is approximately 80%, only 57% * 80% of the KeyPhrases extracted directly from a website will be accurate, that is, about 45%.

Here are the keywords extracted by Extractor directly from the ZDNet article shown in FIG. 1: Lane, Ellison, ZDNet, Oracle, business, news, Larry, Tech, Shop, executives, Internet, blasts Ellison. The bolded keywords (5/12=41%) were extracted because of the 43% of irrelevant words. The extracted highlights are as follows: 1. ZDNet: News: Lane gets new job, blasts Ellison. 2. Business>. 3. Former top lieutenant Ray Lane and Oracle CEO Larry Ellison continue to battle, even as Lane takes a job with Kleiner Perkins. 4. Ray Lane, former No. 2 executive at Oracle Corp., hardly has a bad thing to say about his former employer—except that it is a company full of yes men who tend to be less than candid about their products.

Most news-related web pages and HTML-created emails contain frames which are non-relevant to the contents of the news article. These frames contain links to related articles, to other web sites or publicity. This information can be useful for the visitor of the web site but are irrelevant to the subject discussed. Eliminating such frames is therefore useful for both extracting the contents of the page and, eventually, summarizing this content. Most of the time, these frames are placed in HTML tables. These tables help setting the display of the page and its semantics.

International application WO 98/47083 to Richard Weeks describes a method for summarizing data sets in which appearances of specific keywords are counted and the keywords are ranked to extract the most used keywords and produce a summary of the initial text.

The article entitled “Extracting Semistructured Information From The Web” published by Hammer J et al. on Mar. 16, 1997 presents a method for moving data from the WWW into databases to ensure that data can be searched more efficiently. It describes an extractor which can isolate HTML pages and convert that data into database objects.

There is therefore a need for a text extractor which cleans superfluous content from web pages, especially when this superfluous content is placed in tables in order to extract only the most meaningful content.

### SUMMARY OF THE INVENTION

Accordingly, a first object of the present invention is to extract only the relevant information from a document to facilitate the summarizing of the document.

According to a first broad aspect of the present invention, there is provided a method of extracting a portion of text from a document including a plurality of layout cells in at least one table defining a layout of the document. The method comprises identifying layout cells within the document, the layout cells defining a layout of text entities within the document; calculating statistics parameters of the layout cells, at least one of the statistics parameters being the number of words in the layout cells; attributing a point value for each of the layout cells using at least one of the statistics parameters; ranking the layout cells according to the point value; selecting at least one of the layout cells whose point value is above a predetermined threshold; extracting a text content of the selected layout cells.

According to a further aspect of the present invention, there is provided a computer readable memory for storing programmable instructions for use in the execution in a computer of the process of the method of extracting a portion of text from a document.

According to still another aspect of the present invention, there is provided a method of extracting a portion of text from a document including at least one table and cells within the at least one table, for the purposes of generating a summary of contents of the document. The method comprises the step of receiving a signal, the signal containing text extracted according to the method of extracting a portion of text from a document.

According to a further aspect of the present invention, there is provided, in a method of extracting a portion of text from a document including at least one table and cells within the at least one table, for the purposes of generating a summary of contents of the document, a computer data signal embodied in a carrier wave comprising text extracted according to the method of extracting a portion of text from a document.

According to another aspect of the present invention, there is provided a system for extracting a portion of text from a document including at least one table and cells within the at least one table, for the purposes of generating a summary of contents of the document. The system comprises: a cell identifier for identifying cells within the document; a statistics calculator for determining a text size of the cells; a cell selector for selecting some of the cells using the text size of the cells; a text extractor for extracting in a text only output a text content of the selected cells; whereby the text only output extracted can be used to produce a summary of a portion of text of the document excluding text from non-selected cells.

### BRIEF DESCRIPTION OF THE DRAWINGS

These and other features, aspects and advantages will become better understood with regard to the following description and accompanying drawings, wherein:

FIG. 1 is a screen shot of a news web page in which formatting tables have been highlighted;

FIG. 2 is an illustration of the internal structure of a document;

FIG. 3 is a web page created using the source code of Table 3;

FIG. 4 is resulting hierarchical tree structure of the web page document of FIG. 3 using the algorithm of Table 2;

FIG. 5 is a flow chart of the method according to a preferred embodiment of the present invention; and

FIG. 6 is a block diagram of a system according to a preferred embodiment of the present invention.

### DETAILED DESCRIPTION OF THE PREFERRED EMBODIMENT

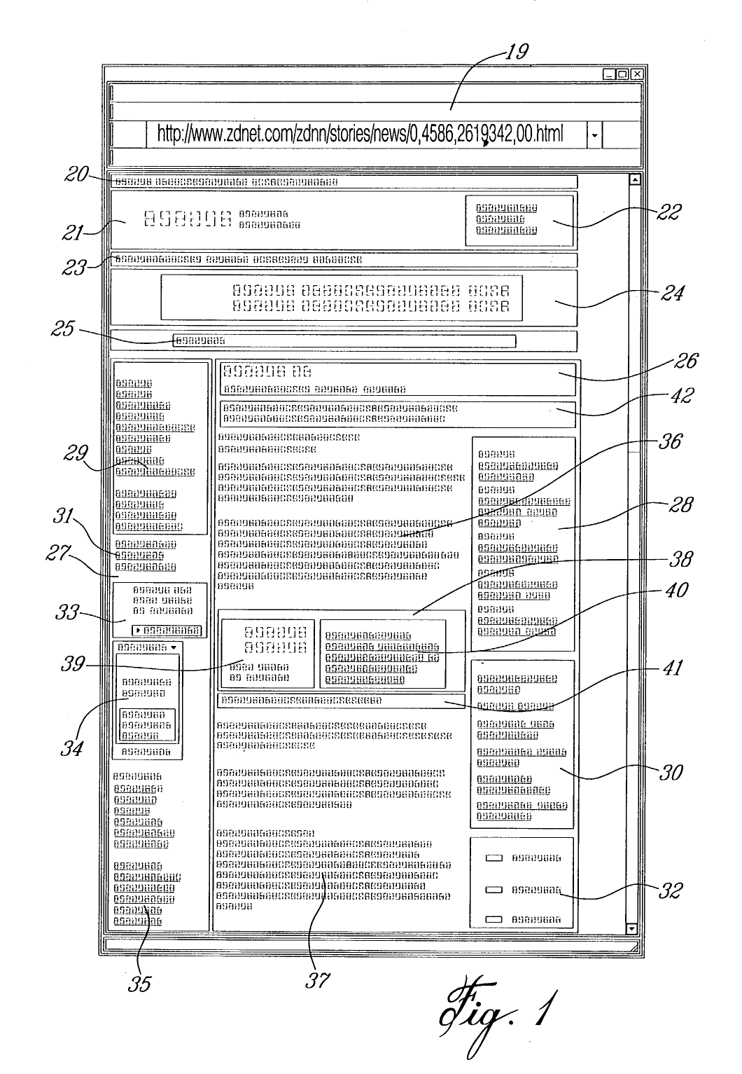

FIG. 1 shows a web page of news which contains many tables. Each table has been framed to illustrate the number of tables and sub-tables used to display and organize the contents of the web page. The web page shown was available at www.zdnet.com/zdnn/stories/news/0,4586,2619342,00.HTML on Oct. 17, 2000. It contains a news article entitled “Lane gets new job, blasts Ellison”, written by Lee Gomes, published on Aug. 24, 2000. As with many news-related web sites, the page contains, in addition to the text of the article, many additional links, images, ads and comments distributed around the core content of the article.

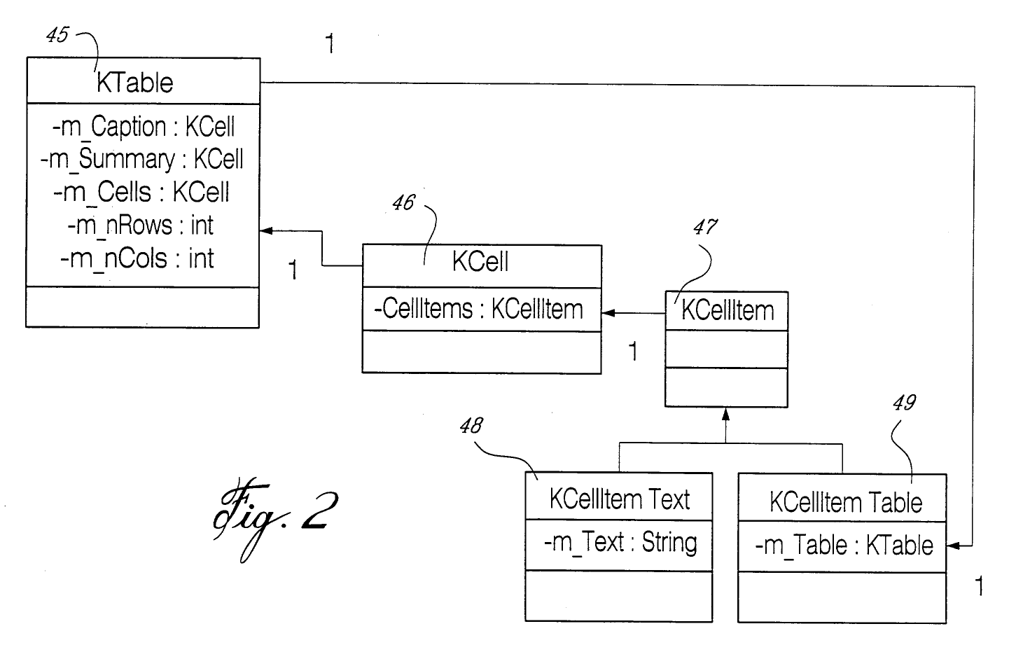

FIG. 2 is the preferred internal structure used to work with the HTML document which contains tables. It shows how using tables facilitates the organization of the information and also how the body text of the page can be buried in sub-tables of sub-tables. As is apparent from FIG. 2, each cell 46 belongs to one table 45, each table 45 has one or more cells 46, each cell 46 has one or more cell items 47, each cell item 47 belongs to one cell 46. A cell item 47 can be text 48 or another table 49. This is the structure used by the algorithm of the present invention to extract information.

The preferred embodiment of the present invention, uses essentially two main steps: 1) Document Structure Extraction and Accumulation of Statistics on the Contents of the Document. 2) Tally of the Points and Generation of the Results.

Document Structure Extraction and Accumulation of Statistics on the Contents of the Document.

The first step consists in reading the document object model (DOM) of a document and to transform it into a representation of its internal structure (as shown in FIG. 2) which is more user friendly, at an algorithm level, at a processing level and at a programming level. The DOM is received as a COM object of type IHTMLDocument2 (MSHTML). The Document Object Model (DOM) is a standard internal representation of the document structure and is used to easily access components and delete, add or edit their content, attributes and style. In essence, the DOM makes it possible for programmers to write applications which work properly on all browsers and servers, and on all platforms. While programmers may need to use different programming languages, they do not need to change their programming model. The Document Object Model is a platform- and language-neutral interface that will allow programs and scripts to dynamically access and update the content, structure and style of documents. There are a plurality of versions called levels of DOM. The first, the DOM XML, relies on an internal tree-like representation of the document, and enables to traverse the hierarchy accordingly. The standard model of viewing a document is as a hierarchy of tags, with the computer building up an internal model of the document based on a tree structure. Meanwhile the HTML DOM provides a set of convenient easy-to-use ways to manipulate HTML documents. The initial HTML DOM merely describes methods (for example), for accessing an identifier by name, or a particular link. The HTML DOM is sometimes referred to as DOM Level 0 but has been imported into DOM Level 1. The HTML and XML DOMs form part of DOM level 1. DOM level 2 includes DOM level 1 but adds a number of new features. IHTMLDocument2 is the implementation done by Microsoft of the HTML DOM Level 2.

Once the structure of the DOM is represented in a user friendly format, it is then possible to extract data useful for compiling statistics on the contents by traveling through this hierarchical structure. Table 2 below is a simplified version of the pseudo-code of the preferred embodiment of the present invention which allows such an extraction.

TABLE 2
Document Structure Extraction and Accumulation of Statistics
on the Content

ExtractDocumentStructure(p_Document : IHTMLDocument2) : KTable
Begin

Ktable parsedDocument
// Extract Document Title
//
KcellItem pCellItem.Text(p_Document.get_title( ));
Kcell pCell.AddCellItem(pCellItem);
parsedDocument.AddCell(pCell);
// Get a pointer to the body element.
//
IHTMLDOMNode pBodyNode = p_Document.get_body( );
// And parse the document.
//
Kcell pBodyCell;
RecursiveParse( pBodyNode, pBodyCell, false );
parsedDocument.AddCell(pBodyCell);
return parsedDocument;

End
RecursiveParse(p_Node:IHTMLDOMNode, p_Cell:KCell, p_bInHref:bool)
Begin

// Iterate through all children.
//
IHTMLDOMNode pNodeCurrent = p_Node;
while( pNodeCurrent )
Begin

if( pNodeCurrent == IHTMLDOMTextNode )
Begin

// It is a text only node.
// Extract text and add it to current cell
KcellItem pCellItem(pNodeCurrent.get_data( ));
// Compute word stats.
//
integer nWords = CountWords(pCellItem);
p_Cell−>AddWords( nWords, p_bInHref );

end
else if( pNodeCurrent == IHTMLAnchorElement )
Begin

// If it is a <A HREF>, proceed with the children.
If( pNodeCurrent.hasChildNodes( ) )
begin

// We now are inside a Href.
if( !p_bInHref )

p_Cell.AddLinks( 1 );
IHTMLDOMNode pChild = pNodeCurrent.get_firstChild( );

RecursiveParse( pChild, p_Cell, true );

end

End
else if( pNodeCurrent == IHTMLImageElement )
Begin

p_Cell.AddImages( 1 );
KcellItem pCellItem(pNodeCurrent.get_alternateText( ));
// Compute word stats.
//
integer nWords = CountWords(pCellItem);
p—Cell−>AddWords( nWords, true );

End
else if( pNodeCurrent == IHTMLTable )
Begin

p_Cell.AddTables( 1 );
// If it is a table, proceed with all table cells
//
Ktable pSubTable;
KcellItem pNewCellItem.Table(pSubTable);
p_Cell.AddCellItem( pNewCellItem );
// Retrieve column and row information.
//
pSubTable.Dimensions=GetTableDimensions(pNodeCurrent);
// Retrieve table caption.
//
IHTMLDOMNode pCaption = pNodeCurrent.get_caption();
RecursiveParse( pCaption, subTable.Caption, false );
// Retrieve table summary.
//
IHTMLDOMNode pSummary = pNodeCurrent.get_summary( );
RecursiveParse( pSummary, subTable.Summary, false );
// Extract content cell by cell
//
for(integer iRow=0; iRow<pSubTable.RowCount; iRow++ )
begin

for(integer iCell=0; iCell<pSubTable.CellCount; iCell++)

Begin

IHTMLTableCell pCell = pNodeCurrent.get_cell(iRow,iCell);
KCell newCell;
// Extract content
RecursiveParse( pCell, newCell, false );
subTable.TableCell(iRow, iCell) = newCell;

End

end

End
Else
Begin

// Proceed with the children.
//
If( pNodeCurrent.hasChildNodes( ) )
begin
IHTMLDOMNode pChild = pNodeCurrent.get_firstChild( );
RecursiveParse( pChild, p_Cell, p_bInHref );
end

End
pNodeCurrent = pNodeCurrent.get_nextSibling( );

End

End

Although the previous algorithm only supports the DOM2 implementation of Microsoft (the library MSHTML which contains the objects IHTMLDocument 2, IHTMLOMNode, IHTMLDOMTextNode, IHTMLTableElement, . . . ). It is to be understood that it would be apparent to one skilled in the art to introduce code for customers who do not have the DOM2 implementation of Microsoft.

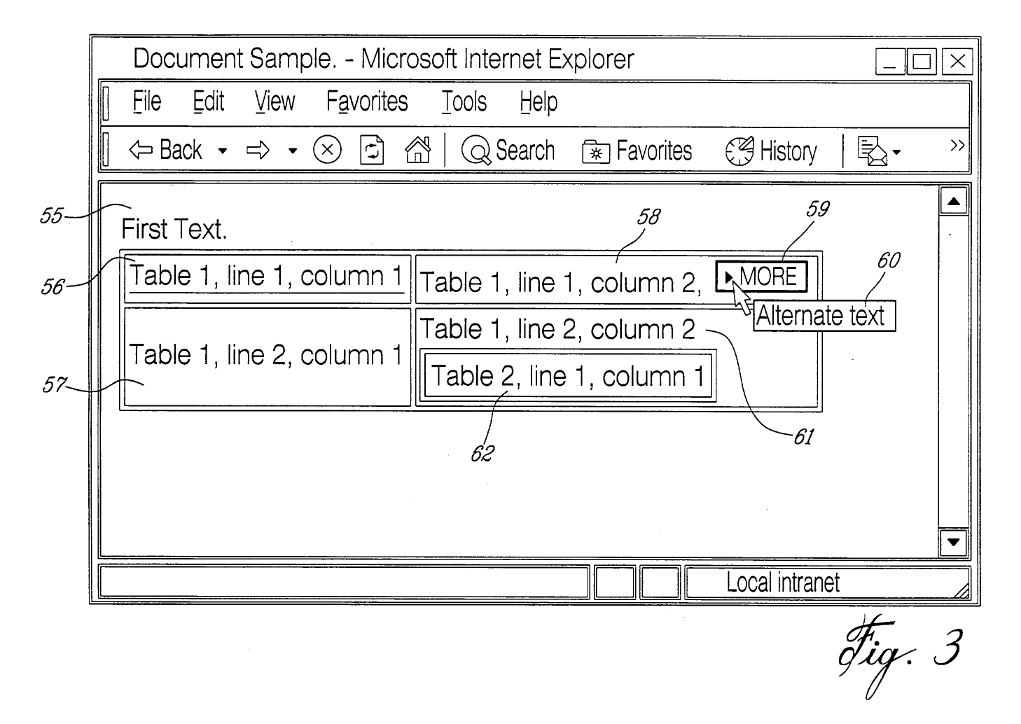

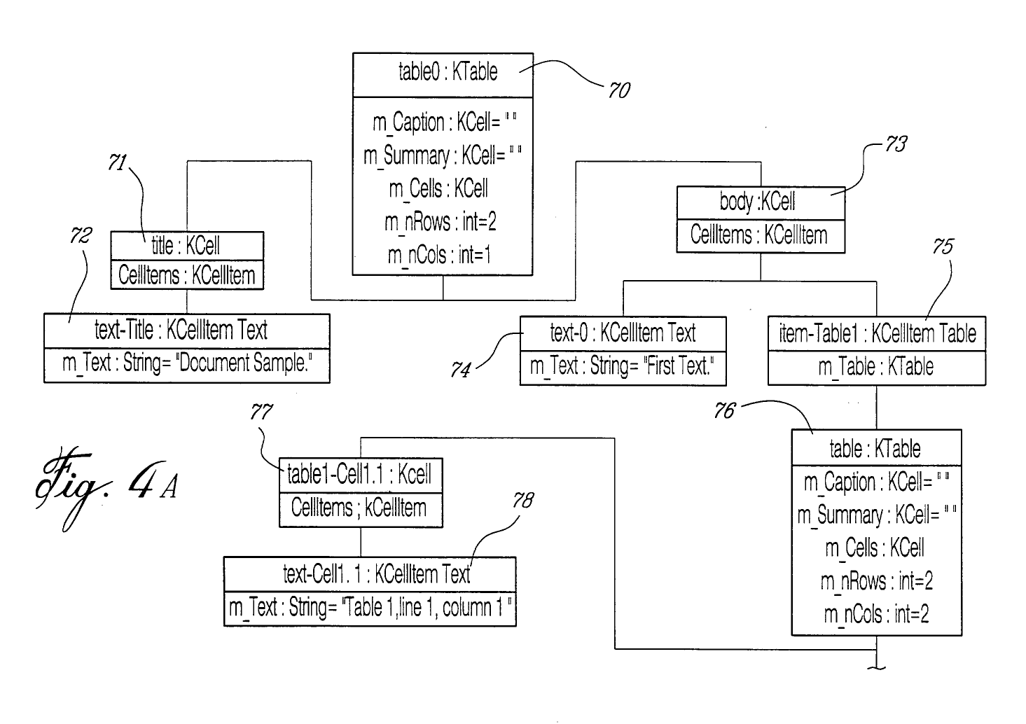

Table 3 is an example of HTML source code used to display the web page of FIG. 3. FIG. 3 is a web page created using the source code of Table 3. It comprises introductory text 55, a hyperlink 56 in line 1, col. 1 of table 1, a text entry in line 2, col. 1 of table 1, an image 59 and a test entry 58 at line 1, col. 2 of table 1 together with alternate text 60 and a table 62 within a cell 61 of a table at line 2, col. 2 of table 1.

TABLE 3
Source code used to create the web page of FIG. 3

<HTML>
<HEAD>

<TITLE>Document Sample.</TITLE>

</HEAD>
<BODY>
First Text.
<TABLE border>

<TR>

<TD>

<A Href=“www.copernic.com”>Table 1, line 1, column 1</A>

</TD>

<TD>Table 1, line 1, column 2,

<IMG SRC=“http://www.copernic.com/images/left-navbar/more-

button.gif” ALT=“Alternate Text”>

</TD>

</TR>
<TR>

<TD>Table 1, line 2, column 1</TD>
<TD>Table 1, line 2, column 2

<TABLE border>

<TR> <TD>Table 2, line 1, column 1</TD> </TR>

</TABLE>

</TD>

</TR>

</TABLE>
</BODY>
</HTML>

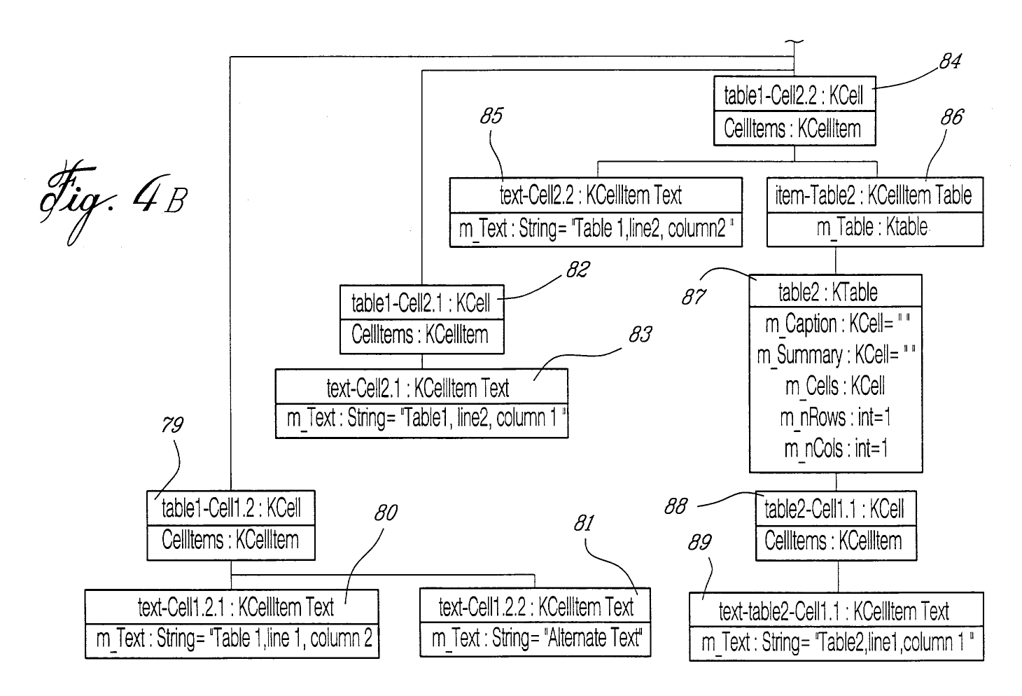

FIG. 4 is an example of the hierarchical structure of the document obtained using the pseudo-code of Table 2 on the web page of FIG. 3. The whole web page is considered to form Table0 70. It has two rows and one column, it doesn't have a caption or a summary and has a number KCell of cells. Its title 70 is in a text string 72 equal to “Document Sample”. The body of the table 73 comprises cell items. The first cell item is a string of text 74 comprising “First Text.” The second cell item is a table 75. Table 75 has 2 rows and 2 columns 76. Table 75 has four items as follows: a text string 78 in cell 77, a text string 80 and some alternate text 81 in cell 79, a text string 83 in cell 82 and a text string 85 together with another table 86 in cell 84. The table 86 comprises 1 row and 1 column and the only cell 88 comprises a text string 89.

Tally of the Points and Generation of the Results.

The generation of the results is preferably the following:

1. Extract statistics (such as number of words, depth, etc.) from the whole document;

2. Travel through all tables of the document and tally their points (RankTable);

2.1. If the number of points of a table is too low, (LowThreshold), remove the table;

3. Sort the tables in order of number of points;

4. Identify the tables with the highest numbers of points (HiThreshold) and save them in the GoodTables list;

5. Travel through the GoodTables list. For each sub-table of a table of the GoodTables list;

5.1. If its number of points is high enough (WinnerLowThreshold), the table is added to the GoodTables list;

6. Generate the results by travelling through all tables of the document;

6.1. If the current table is in the GoodTables list, travel through all of its cells;

6.1.1. Calculate the number of points of each cell (RankCell)

6.1.2. If the number of points of each cell is sufficient (CellLowThreshold), extract the text from the cell.

Following is a table of the thresholds used during the tally of points:

TABLE 4
Preferred Thresholds used.

| Low- | | | |
|---|---|---|---|
| Threshold | HiThreshold | WinnerLowThreshold | CellLowThreshold |
| 0.20 | 0.05 | 0.30 | 0.50 |

Extracting Statistics from a Table(GetTableStatistics)

GetTableStatistics(p_Table: KTable): KStatistics

For all cells of the table

1 NumberOfWords=Calculate the total number of words in the table.

2 NumberOfWordsInLinksOrInImages=Calculate the number of words in the links or the images.

3 NumberOfCells=Calculate the total number of cells.

4 WordsPerCell=(NumberOfWords−NumberOfWordsInLinksOrInImages)/NumberOfCells

It will be understood that the number of words calculation can be modified to be a count of the number of characters, the number of bits or can be transformed to be a count of the number of sentences (by identifying an uppercase letter followed by a plurality of characters and, eventually, a period), a number of meaningful words (by removing occurrences of “the”, “a”, “an”, “but”, “and”, etc.). One could also choose to count cells if they contain at least one verb or at least a period.

Calculating the Number of Points of a Table (RankTable):

RankTable(p_Table: KTable, p_MainStats: KStatistics): float

Score=0, Depth=0

For all sub-tables of p_Table of depth Depth (0 . . . n):

1. TableStats=Extract table statistics (GetTableStatistics)

2. DepthFactor=½*Depth

3. LocalScore+=DepthFactor*LinkDensityFactor*(1−TableStats.NumberOfWordsInLinksOrInImages/TableStats.NumberOfWords)

4 LocalScore+=DepthFactor*WordsPerCellFactor*TableStats.WordsPerCell/p_MainStats.MaximumWordsPerCell

5 LocalScore+=DepthFactor*WordCountFactor*(TableStats.NumberOfWords−TableStats.NumberOfWordsInLinksOrInImages)/(p_MainStats.NumberOfWords−p_MainStats.NumberOfWordsInLinksOrInimages)

6 Score=Score+LocalScore/(Number of tables of depth Depth)

The tally of points function uses a two-dimensional scale. The points are calculated by the characteristics of the table and by all of the characteristics of the items dependent from the table. The deeper a sub-table is in the hierarchical tree of structure of the page, the less it contributes to the final number of points. All tables of a specified depth (Depth) contribute to the final amount of points equally. Following is a table of the scale used for the tally of points.

TABLE 5
Scale Preferably Used to Tally the Points.

| | LinkDensityFactor | WordsPerCellFactor | WordCountFactor |
|---|---|---|---|
| Depth | 0.33 | 0.33 | 0.33 |
| 1 | (½¹) * 0.33 = 0.165 | (½¹) * 0.33 = 0.165 | (½¹) * 0.33 = 0.165 |
| 2 | (½²) * 0.33 = 0.0825 | (½²) * 0.33 = 0.0825 | (½²) * 0.33 = 0.0825 |
| 3 | (½³) * 0.33 = 0.04125 | (½³) * 0.33 = 0.04125 | (½³) * 0.33 = 0.04125 |
| . . . | | | |
| n | (½ⁿ) * | (½ⁿ) * | (½ⁿ) * |
| | LinkDensityFactor | WordsPerCellFactor | WordCountFactor |

The values of the parameters HiThreshold, WinnerLowThreshold, CellLowThreshold, LinkDensityFactor, WordsPerCellFactor and WordCountFactor are preferred values which have been obtained through experimentation. These values are independent of the properties of the documents such as their size, their origin, etc. It would be possible to use other values to obtain a suitable set of parameters for the extraction.

It should be understood that all counts done on contents of cells can be weighted by parameters to emphasize the importance of characteristics of the cells. It should therefore be understood that all additions, subtractions and multiplication can be weighted by appropriate parameters.

Calculating the Number of Points of a Cell (RankCell):

During the final pass for the generation of results, a last tally of points is done at the cell's level (RankCell). This tally of points is used to eliminate the cells which contain too many links with respect to body text.

RankCell(p_Cell: KCell): float

Return (1−p_Cell.NumberOfWordsInLinksOrInImages/NumberOfWords)

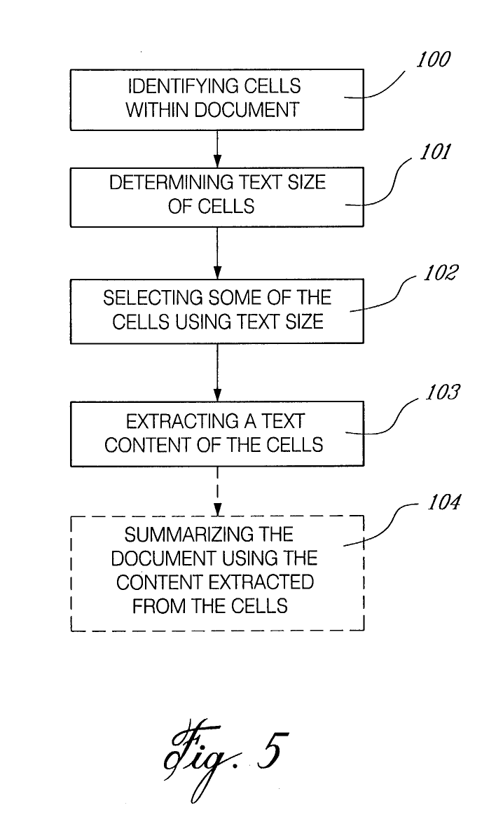

FIG. 5 is a flow chart of the general methodology used in the previous algorithms. The cells in the document are identified 100, then, a text size for these cells is determined 101. Some cells are then selected using the text size information 102. For the cells selected, the text content is extracted from the cells 103. An optional step of summarizing the document using the content extracted from the cells is then possible 104.

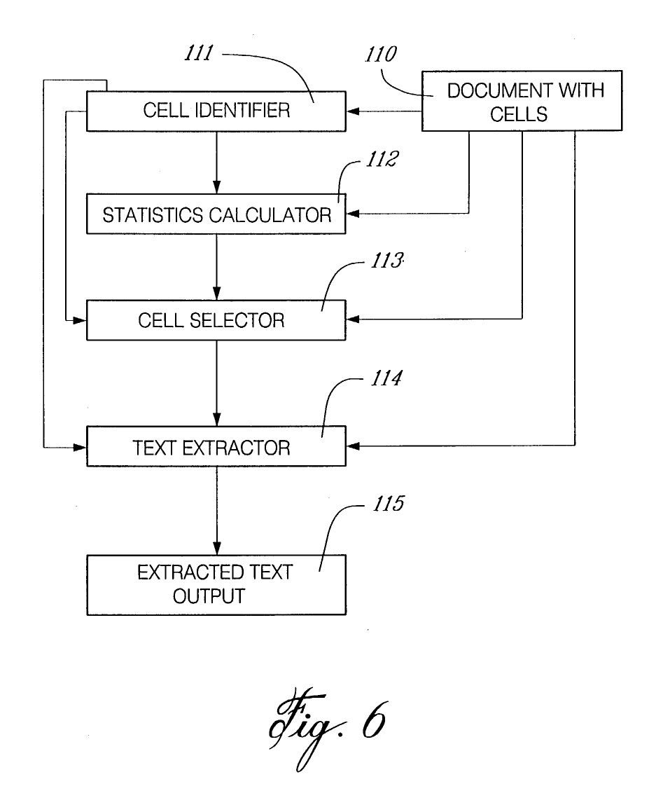

FIG. 6 is a block diagram of a system according to a preferred embodiment of the present invention. A document 110 with cells is provided. A cell identifier 111 identifies the cells within the document 110. A statistics calculator 112 uses the document 110 to calculate statistics on at least some of the cells of the document. A cell selector 113 uses the list of cells identifies and the statistics together with the document to select the cells relevant to the contents of the document. A text extractor 114 uses the list of cells selected and the document 110 to extract the text output 115.

When the previous algorithms are used on the web page of FIG. 1, the text extracted contains 860 words of which 100% (850 words) of the relevant words contained in the news article portion of the web page document. The extracted text is as follows in Table 6:

TABLE 6
Extracted text

Lane gets new job, blasts Ellison-
Former top lieutenant Ray Lane and Oracle CEO Larry Ellison continue to
battle, even as Lane takes a job with Kleiner Perkins.
By Lee Gomes , WSJ Interactive Edition-
August 24, 2000 7:51 AM PT-
Ray Lane, former No. 2 executive at Oracle Corp., hardly has a bad thing to
say about his former employer -- except that it is a company full of yes men
who tend to be less than candid about their products.
Lane abruptly left the business-software giant in June after an eight-year
stint. One reason was that his responsibilities as president and chief
operating officer had been reduced by Lawrence Ellison, Oracle's (Nasdaq:
ORCL ) chief executive. Lane, 53 years old, said following his departure that
he wanted to devote more time to his two young children by his second
marriage.
More stories on: Ellison vs. Lane
Wednesday, Lane announced that he will become a general partner at Kleiner
Perkins Caufield & Byers, the prominent Silicon Valley venture-capital firm.
And in an interview scheduled with that announcement, Lane harshly criticized
Ellison, making clear that his departure from Oracle wasn't amicable. In
response to Lane's comments, Ellison strongly defended himself and the
company.
A great admirer yet-
Lane said he remains a great admirer of Oracle and Ellison. He said, for
example, that Ellison's oversight of the main Oracle database product in the
early 1990s “saved” the company, and that lately, Ellison has “reinvigorated”
Oracle to take advantage of the opportunities presented by the Internet. That
work made Lane's net worth, based largely in Oracle stock, soar to nearly a
billion dollars.
But Lane also said that Ellison is utterly dominating the company right now,
something that might prove to be harmful in the long run, since Oracle won't
be able to develop the strong management team it needs.
‘[The Oracle executives] aren't leaders. They just do what Larry says. They
wouldn't know how to make a decision without Larry making it for them.’-
-- Ray Lane, former No. 2 executive at Oracle-
“It's just like with kids,” Lane said. “If you make all their decisions for
them, they will go out as adults not knowing how to make decisions
themselves.” The executives now reporting to Ellison, said Lane, “are not
decision makers. They aren't leaders. They just do what Larry says. They
wouldn't know how to make a decision without Larry making it for them.”
Lane came to Oracle, of Redwood Shores, Calif., in 1992 at a time when the
company's credibility in the market was low. He said Wednesday that studies
he commissioned at that time found that many customers “would never do
business again with a Larry Ellison company.”
The reason, Lane said, is that Oracle would sell products it didn't have.
“Larry is a visionary, and expresses the vision so well that people believe
it's a product.” When he first got to Oracle, Lane said, “managers would be
willing to take the order and make a lot of money,” even though the products
often didn't exist. “That's the discipline I put into the company,” he said.
“I told the sales force, ‘After what Larry says is the vision, tell the
customer the truth about what we can actually deliver.’ ”
‘Needs more balance’-
Lane indicated that he is worried that with him gone, Oracle might lapse back
to its old ways. “The company needs more balance,” he said.
Ellison rejected his former deputy's criticisms.
Oracle's managers, Ellison said, were in many cases chosen by Lane himself.
“He is criticizing his own team for being weak. When did they become yes men?
I am thrilled they are all here. They are delivering exceptional results.”
Ellison also said the company doesn't sell products it doesn't have.
“He is the soul, the conscience of Oracle, and the other 45,000 of us are
criminals?” Ellison asked. “It's astounding. We don't sell products that
don't exist because it's against the law.”
Even while he was at Oracle, Lane was sometimes outspoken on the subject of
Ellison. Once, for example, he described how top executives of Boeing Corp.
were no longer dealing with Oracle about an important “business-to-business”
contract because they were angry that Ellison had publicly stated,
incorrectly, that Oracle had won the deal.
And his latest comments about Oracle should be viewed in the context of his
new job. At Kleiner Perkins, he will be helping start-up companies in
business-to-business software and services, some of which may potentially
compete with Oracle.
Lane said he was attracted to the venture-capital job in large part because
it will mean less travel. “When you are spending 70 percent of your time on
airplanes, you have to step back and say, ‘Why am I doing this?’ ” He also
predicted a looming shakeout at many Internet companies, which will make his
sort of operational experience even more valuable, since he will be able to
provide guidance to the surviving companies.
Lane was originally slated to stay on Oracle's board following his departure.
He said Wednesday, though, that he might leave it in the fall, when his term
expires.
See also: Business section-
Enter a company-

This extracted text can then be put through a summarizer of the prior art to obtain a relevant summary. For example, if the previous extracted text is put through the summarizer of CNRC, the following summary is obtained (which is fully relevant):

Keyphrases: Lane, Oracle, Ellison, Larry, Executives, Business, Kleiner Perkins, Ray Lane, Vision, sell products, Managers, chief operating officer.

Highlights: 1. Lane gets new job, blasts Ellison-Former top lieutenant Ray Lane and Oracle CEO Larry Ellison continue to battle, even as Lane takes a job with Kleiner Perkins. 2. The executives now reporting to Ellison, said Lane, “are not decision makers. 3. He said Wednesday that studies he commissioned at that time found that many customers “would never do business again with a Larry Ellison company.”

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A method of extracting a portion of text from a document including a plurality of layout cells in at least one table defining a layout of said document, the method comprising:
identifying layout cells within said document, said layout cells defining a layout of text entities within said document;
calculating statistics parameters of the layout cells, at least one of said statistics parameters being the number of words in said layout cells;
attributing a point value for each of said layout cells using at least one of said statistics parameters;
ranking said layout cells according to said point value;
selecting at least one of said layout cells whose point value is above a predetermined threshold;
extracting a text content of said selected layout cells.

2. A method as claimed in claim 1, wherein said identifying layout cells within said document comprises building a hierarchical tree structure for said document and said calculating statistics parameters comprises using said hierarchical tree structure to determine a depth of said layout cells within said structure and said selecting comprises
selecting cells having a large number of words value and a low depth value.

3. A method as claimed in claim 1, wherein said number of words is calculated by determining a number of hyperlinked words contained in said layout cells and subtracting said number of hyperlinked words from a total number of words contained in said layout cells to obtain a number of words of a text content of said layout cells.

4. A method as claimed in claim 1, wherein said number of words is calculated by determining a number of words of an alternate text element contained in said layout cells and adding said number of words of said alternate text element to a total number of words contained in said layout cells to obtain a complete number of words of said layout cells.

5. A method as claimed in claim 1, wherein said identifying layout cells comprises
identifying at least one table defining a layout of said document; and
identifying at least one layout cell within each said at least one table.

6. A method as claimed in claim 5, wherein said at least one layout cell within each said at least one table comprises at least one sub-table within said at least one layout cell.

7. A method as claimed in claim 5, wherein said calculating statistics parameters comprises
determining at least one of a number of words in said table, a number of words in links or images of said table, a number of layout cells in said table, a number of words per layout cell in said table, a depth of said table and a maximum number of words per layout cell;
and wherein said selecting comprises:
calculating a score for said table;
if said score is lower than a low threshold value, eliminating said table;
if said score is higher than a high threshold value, selecting said table.

8. A method as claimed in claim 7, wherein said high threshold value is equal to said low threshold value.

9. A method as claimed in claim 5, wherein, for each sub-table included in a layout cell within said selected table, the method further comprises:
calculating a sub-score for each said sub-table;
if said sub-score is higher than a sub-table threshold value, selecting said sub-table to be a selected table.

10. A method as claimed in claim 1, wherein said calculating statistics parameters comprises:
determining a number of words contained in said layout cells; and
determining a number of a number of words in links or images of said layout cells;
and wherein said attributing comprises
calculating a layout cell score value for said layout cells using said number of words in links or images and said number of words.

11. A method as claimed in claim 5, wherein said calculating statistics parameters comprises:
determining a number of words contained in each said layout cells of said selected table; and
determining a number of a number of words in links or images of said layout cells of said selected table;
and wherein said attributing comprises:
calculating a layout cell score value for said layout cells of said selected table using said number of words in links or images and said number of words;
and wherein said selecting comprises:
if said layout cell score value is higher than a layout cell threshold value, selecting said layout cell.

12. A method as claimed in claim 1, wherein said document is an HTML source code file and said identifying layout cells within said document comprises using HTML source code from said file to identify said layout cells.

13. A method as claimed in claim 12, wherein said using HTML source code comprises recognizing HTML layout tags identifying layout cells within said document.

14. A computer readable memory for storing programmable instructions for use in the execution in a computer of the method of claim 1 to.

15. A method of extracting a portion of text from a document including a plurality of layout cells in at least one table defining a layout of said document, the method comprising:
receiving a signal, said signal containing text extracted according to the method as defined in claim 1.

16. In a method of extracting a portion of text from a document including a plurality of layout cells in at least one table defining a layout of said document, a computer data signal embodied in a carrier wave comprising:
text extracted according to the method as defined in claim 1.

17. A text extractor for extracting a portion of text from a document including a plurality of layout cells in at least one table defining a layout of said document, comprising:
a cell identifier for identifying layout cells within said document, said layout cells defining a layout of text entities within said document;
a statistics calculator for calculating statistics parameters of the layout cells, at least one of said statistics parameters being the number of words in said layout cells;
a point value determiner for attributing a point value for each of said layout cells using at least one of said statistics parameters;
a cell ranker for ranking said layout cells according to said point value;
a cell selector for selecting at least one of said layout cells whose point value is above a predetermined threshold;
a text provider for extracting a text content of said selected layout cells.

18. A text extractor as claimed in claim 17, wherein said cell identifier comprises a tree builder for building a hierarchical tree structure for said document and wherein said statistics calculator comprises a depth determiner for determining a depth of said layout cells within said structure using said hierarchical tree structure and wherein said cell selector selects some of said layout cells having a large number of words value and a low depth value.

19. A text extractor as claimed in claim 17, wherein said statistics calculator comprises a hyperlinked word calculator for calculating a number of hyperlinked words contained in said layout cells and subtracting said number of hyperlinked words from a total number of words contained in said layout cells to obtain a number of words of a text content of said layout cells.

20. A text extractor as claimed in claim 17, wherein said statistics calculator comprises an alternate text calculator for calculating a number of words of an alternate text element contained in said layout cells and adding said number of words of said alternate text element to a total number of words contained in said layout cells to obtain a complete number of words of said layout cells.

21. A text extractor as claimed in claim 17, wherein said cell identifier identifies at least one table defining a layout of said document; and identifies at least one layout cell within each said at least one table.

22. A text extractor as claimed in claim 21, wherein said at least one layout cell within each said at least one table comprises at least one sub-table within said at least one layout cell.

23. A text extractor as claimed in claim 21, wherein said statistics calculator determines at least one of a number of words in said table, a number of words in links or images of said table, a number of layout cells in said table, a number of words per layout cell in said table, a depth of said table and a maximum number of words per layout cell;
and wherein said cell ranker calculates a score for said table;
and wherein said cell selector
if said score is lower than a low threshold value, eliminates said table;
if said score is higher than a high threshold value, selects said table.

24. A text extractor as claimed in claim 23, wherein said high threshold value is equal to said low threshold value.

25. A text extractor as claimed in claim 21, wherein said statistics calculator calculates a sub-score for each said sub-table included in a layout cell within said selected table; and said cell selector
if said sub-score is higher than a sub-table threshold value, selects said sub-table to be a selected table.

26. A text extractor as claimed in claim 17, wherein said statistics calculator
determines a number of words contained in said layout cells; and
determines a number of a number of words in links or images of said layout cells
and wherein said cell ranker
calculates a layout cell score value for said layout cells using said number of words in links or images and said number of words;
and wherein said cell selector
if said layout cell score value is higher than a layout cell threshold value, selects said layout cell.

27. A text extractor as claimed in claim 21, wherein said statistics calculator:
determines a number of words contained in each said layout cells of said selected table; and
determines a number of a number of words in links or images of said layout cells of said selected table;
and wherein said cell ranker
calculates a layout cell score value for said layout cells of said selected table using said number of words in links or images and said number of words;
and wherein said cell selector
if said layout cell score value is higher than a layout cell threshold value, selects said layout cell.

28. A text extractor as claimed in claim 17, wherein said document is an HTML source code file and said cell identifier uses HTML source code from said file to identify said layout cells.

29. A text extractor as claimed in claim 28, wherein said cell identifier recognizes HTML layout tags identifying layout cells within said document.
